(19) United States
(12) Patent Application Publication
(10) Pub. No.: US 2023/0267371 A1
(43) Pub. Date: Aug. 24, 2023

(54) APPARATUS, METHOD AND COMPUTER PROGRAM FOR GENERATING DE-IDENTIFIED TRAINING DATA FOR CONVERSATIONAL SERVICE

(71) Applicant: TUNiB Inc., Seongnam-si (KR)

(72) Inventor: Kyu Byong PARK, Seongnam-si (KR)

(73) Assignee: TUNiB Inc., Seongnam-si (KR)

(21) Appl. No.: 18/111,049

(22) Filed: Feb. 17, 2023

(30) Foreign Application Priority Data
Feb. 18, 2022 (KR) 10-2022-0021195

(51) Int. Cl. G06N 20/00; G06F 21/62

(52) U.S. Cl. CPC G06N 20/00; G06F 21/6254

(57) ABSTRACT

An apparatus for generating de-identified training data for conversational service includes a sentence detection unit configured to detect at least one sentence including personal information in a conversation between a user device and a chatbot; a de-identification target sentence detection unit configured to input conversational data including the at least one sentence into a personal information identification model and detect a de-identification target sentence through the personal information identification model; a search unit configured to search a predefined de-identification target token from the conversational data when a de-identification target sentence is detected from the conversational data; and a training data generation unit configured to generate training data on the conversational data by de-identifying text corresponding to the searched de-identification target token.

### CROSS-REFERENCE TO RELATED APPLICATION

This application claims the benefit under 35 USC 119(a) of Korean Patent Applications No. 10-2022-0021195 filed on Feb. 18, 2022 in the Korean Intellectual Property Office, the entire disclosures of which are incorporated herein by reference for all purposes.

### TECHNICAL FIELD

The present disclosure relates to an apparatus, method and computer program for generating de-identified training data for conversational service.

### BACKGROUND

A chatbot refers to a system implemented to respond to a user through a messenger based on a predetermined response rule. Some chatbots utilize pattern recognition by which a machine can identify voices/text based on artificial intelligence (AI) and big data analysis for smooth conversation, natural language processing by which a computer can recognize human language for use in question answering and translation, semantic web technology by which a computer understands information and makes logical inference, text mining for deriving useful information from data composed of text, and context-aware computing for understanding the situation and context of a conversational partner.

Chatbots with these various technologies mainly perform the role of a customer service center that answers consumer questions through messengers for home shopping, Internet shopping malls, insurance companies, banks, food delivery, and accommodation booking, and has the merit of providing high-quality information with high reliability.

However, when a customer service is provided using a chatbot, personal information of the user may be required, and text data contain various forms of personal information, which can bring about an invasion of personal privacy.

### PRIOR ART DOCUMENT

Korean Patent Laid-open Publication No. 2018-0019869 (published on Feb. 27, 2018)

### SUMMARY

In view of the foregoing, the present disclosure provides an apparatus, method and computer program capable of detecting at least one sentence including personal information in a conversation between a user device and a chatbot, inputting conversational data including the at least one sentence into a personal information identification model, and detecting a de-identification target sentence through the personal information identification model.

Also, the present disclosure provides an apparatus, method and computer program capable of searching a predefined de-identification target token from conversational data when a de-identification target sentence is detected from the conversational data, and generating training data on the conversational data by de-identifying text corresponding to the searched de-identification target token.

The problems to be solved by the present disclosure are not limited to the above-described problems. There may be other problems to be solved by the present disclosure.

As a means for solving the problems, according to an aspect of the present disclosure, an apparatus for generating de-identified training data for conversational service includes a sentence detection unit configured to detect at least one sentence including personal information in a conversation between a user device and a chatbot; a de-identification target sentence detection unit configured to input conversational data including the at least one sentence into a personal information identification model and detect a de-identification target sentence through the personal information identification model; a search unit configured to search a predefined de-identification target token from the conversational data when a de-identification target sentence is detected from the conversational data; and a training data generation unit configured to generate training data on the conversational data by de-identifying text corresponding to the searched de-identification target token.

According to another aspect of the present disclosure, a method for generating de-identified training data for conversational service, which is performed by a training data generation apparatus includes detecting at least one sentence including personal information in a conversation between a user device and a chatbot; inputting conversational data including the at least one sentence into a personal information identification model and detecting a de-identification target sentence through the personal information identification model; searching a predefined de-identification target token from the conversational data when a de-identification target sentence is detected from the conversational data; and generating training data on the conversational data by de-identifying text corresponding to the searched de-identification target token.

According to yet another aspect of the present disclosure, a non-transitory computer-readable storage medium storing a computer program including a sequence of instructions to generate de-identified training data for conversational service, wherein the computer program includes a sequence of instructions that, when executed by a computing device, cause the computing device to detect at least one sentence including personal information in a conversation between a user device and a chatbot; input conversational data including the at least one sentence into a personal information identification model, and detect a de-identification target sentence through the personal information identification model; search a predefined de-identification target token from the conversational data when a de-identification target sentence is detected from the conversational data; and generate training data on the conversational data by de-identifying text corresponding to the searched de-identification target token.

The above-described aspects are provided by way of illustration only and should not be construed as liming the present disclosure. Besides the above-described embodiments, there may be additional embodiments described in the accompanying drawings and the detailed description.

According to the present disclosure, it is possible to provide an apparatus, method and computer program capable of primarily detecting at least one sentence including personal information in a conversation between a user device and a chatbot.

According to the present disclosure, it is possible to provide an apparatus, method and computer program capable of inputting conversational data including at least one sentence into a personal information identification model, and secondarily detecting a de-identification target sentence through the personal information identification model.

According to the present disclosure, it is possible to provide an apparatus, method and computer program capable of searching a predefined de-identification target token from conversational data when a de-identification target sentence is detected from the conversational data, and generating training data on the conversational data by de-identifying text corresponding to the searched de-identification target token, and thus capable of protecting personal privacy and utilizing data, which are not personal information, for various services while preserving the data.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different figures indicates similar or identical items.

FIG. 1 is a diagram illustrating a configuration of a training data generation apparatus according to an embodiment of the present disclosure.

FIG. 2 is a diagram showing an example of a process of detecting at least one sentence including personal information in a conversation according to an embodiment of the present disclosure.

FIG. 3A to FIG. 3C are diagrams showing an example of a process of generating training data on conversational data by de-identifying text according to an embodiment of the present disclosure.

FIG. 4 is a flowchart showing a method of generating de-identified training data for conversational service, which is performed by a training data generation apparatus, according to an embodiment of the present disclosure.

### DETAILED DESCRIPTION

Hereafter, embodiments of the present disclosure will be described in detail with reference to the accompanying drawings so that the present disclosure may be readily implemented by a person with ordinary skill in the art. However, it is to be noted that the present disclosure is not limited to the embodiments but may be embodied in various other ways. In drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Throughout this document, the term “unit” may refer to a unit implemented by hardware, software, and/or a combination thereof. As examples only, one unit may be implemented by two or more pieces of hardware or two or more units may be implemented by one piece of hardware. However, the “unit” is not limited to the software or the hardware and may be stored in an addressable storage medium or may be configured to implement one or more processors.

Throughout this document, a part of an operation or function described as being carried out by a terminal or device may be implemented or executed by a server connected to the terminal or device. Likewise, a part of an operation or function described as being implemented or executed by a server may be so implemented or executed by a terminal or device connected to the server.

Hereinafter, an embodiment of the present disclosure will be described in detail with reference to the accompanying drawings.

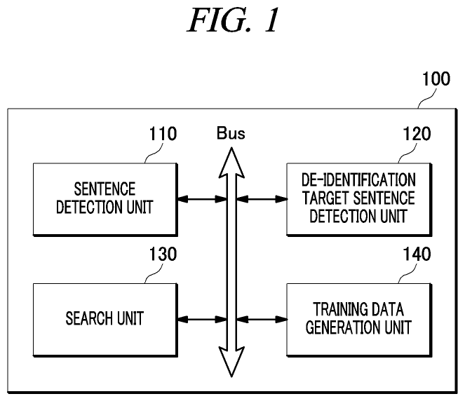

FIG. 1 is a configuration illustrating a configuration of a training data generation apparatus according to an embodiment of the present disclosure. Referring to FIG. 1, a training data generation apparatus 100 may include a sentence detection unit 110, a de-identification target sentence detection unit 120, a search unit 130 and a training data generation unit 140.

The sentence detection unit 110 may detect at least one sentence including personal information in a conversation between a user device and a chatbot. Herein, the chatbot may serve to provide various services (for example, customer relation service, reservation service, concierge service, etc.) related to a product/service. Alternatively, the chatbot may provide a conversational service on free topics.

For example, the sentence detection unit 110 may detect at least one sentence including personal information related to a direct factor by which it is possible to directly identify an individual or an indirect factor by which it is possible to identify an individual in combination with other information.

For example, the direct factor may include names, phone numbers, addresses, birthdates, photos, resident registration numbers, driver license numbers, insurance numbers, passport numbers, account numbers, registration numbers, e-mail addresses, corporate registration numbers, military serial numbers, IDs, i-PINs, and the like.

The indirect factor may include personal characteristics such as sex, year of birth, date of birth, age, nationality, birthplace, residence, district name, postcode, military service, marital status, religion, hobby, society, club, smoking status, alcohol use, vegetarian diet status, matter of interest, etc., physical characteristics such as blood type, height, weight, waist circumference, blood pressure, eye color, physical examination result, disability type, disability severity, disease name, disease code, medication code, medical treatment details, etc., career characteristics such as school name, major name, school year, grade, level, occupation, occupation category, company name, department name, position, credential, work experience, etc., electronic characteristics such as PC specification, password, password question and answer, cookie information, access time, visit time, service usage records, location information, access log, IP address, MAC address, HDD serial number, CPU ID, remote access status, proxy setting status, VPN setting status, USB serial number, mainboard serial number, UUID, OS version, manufacturer, model name, device ID, network country code, SIM card information, etc., familial characteristics such as spouse, children, parents, siblings, family information, legal representative information, etc., and locational characteristics such as GPS data, RFID reader access records, sensing records at a specific time, Internet access, mobile phone usage records, photo, etc.

Herein, sentences in the conversation between the user device and the chatbot may be stored sequentially in a buffer, and for example, the sentence detection unit 110 may understand the intention of the sentences based on the context of the sentences stored sequentially in the buffer and may detect at least one sentence. For example, the sentence detection unit 110 may understand the intention of a user, such as restaurant reservation under the name of the user or product repair request at the user's address, based on the context of the sentences stored sequentially in the buffer and may detect at least one sentence.

For another example, the sentence detection unit 110 may determine whether the chatbot has asked the user a question which can disclose personal information (for example, a question asking for the name and phone number of the user) based on the context of the sentences stored sequentially in the buffer (for example, when the user wants to make a restaurant reservation through the chatbot, the user requests the chatbot to make a restaurant reservation and the chatbot asks the user for the name and phone number of the user in response to the request for restaurant reservation) and may detect at least one sentence.

The sentence detection unit 110 may calculate a first probability that the at least one sentence will include personal information. For example, the sentence detection unit 110 may calculate a first probability that the at least one sentence includes personal information.

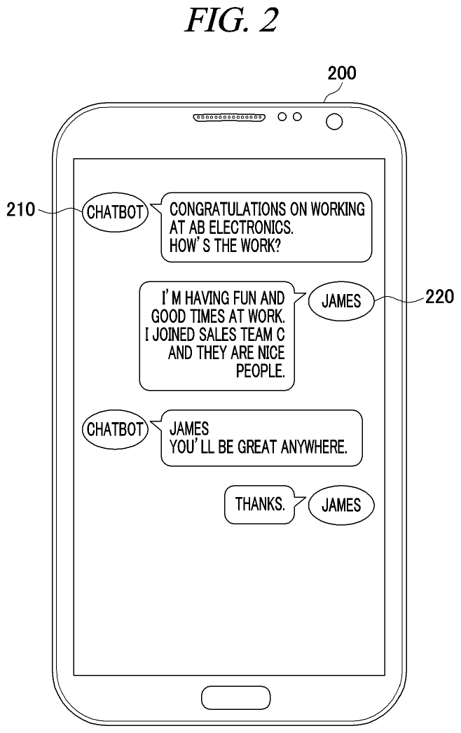

Hereinafter, a process of detecting at least one sentence including personal information in a conversation between a user device and a chatbot will be described with reference to FIG. 2.

FIG. 2 is a diagram showing an example of a process of detecting at least one sentence including personal information in a conversation according to an embodiment of the present disclosure. Referring to FIG. 2, a user 220 can have a conversation with a chatbot 210 using a user device 200. Herein, the chatbot 210 may serve to provide a conversational service related to employment.

For example, it can be assumed that the user 220 and the chatbot 210 have a conversation, such as “chatbot 210: Congratulations on working at AB Electronics. How's the work?”, “user 220: I'm having fun and good times at work. I joined sales team C and they are nice people”, “chatbot 210: James, you'll be great anywhere”, “user 220: thanks”.

The sentence detection unit 110 may detect, as a sentence including personal information, a sentence indicating a job where the user 220 works, such as “AB Electronics”, from among the sentences written by the chatbot 210.

Also, the sentence detection unit 110 may detect, as a sentence including personal information, a sentence indicating a team where the user 220 works, such as “sales team C”, from among the sentences written by the user 220.

Further, the sentence detection unit 110 may detect, as a sentence including personal information, a sentence indicating the name of the user 220, such as “James”, from among the sentences written by the chatbot 210.

Referring back to FIG. 1, the de-identification target sentence detection unit 120 may input conversational data including at least one sentence into a personal information identification model and detect a de-identification target sentence through the personal information identification model.

For example, when a second probability that each sentence will include personal information is output from the personal information identification model, the de-identification target sentence detection unit 120 may detect a de-identification target sentence using the first probability and the second probability. Herein, all the sentences stored in the buffer may be sequentially input into the personal information identification model, and the second probability for each sentence may be output.

For another example, the sentence detection unit 110 may determine whether the calculated first probability is equal to or higher than a threshold value (for example, 80%). When sentences with the first probability equal to or higher than the threshold value are input into the personal information identification model, the second probability that each sentence will include personal information may be output. The de-identification target sentence detection unit 120 may detect a de-identification target sentence using the second probability.

Herein, the personal information identification model is trained based on a dataset including the conversational data and a labelling of a de-identification target sentence (for example, a de-identification target sentence labelled “1” and the other sentences labelled “0”). For example, the personal information identification model may output the probability that each sentence will include personal information (for example, “1”) as the second probability and may detect a de-identification target sentence using the first probability and the second probability.

Such a personal information identification model can be used as any learning model as long as it is previously trained with a large amount of Korean text data.

When the de-identification target sentence is detected from the conversational data, the search unit 130 may search a predefined de-identification target token from the conversational data. Herein, the de-identification target token may include, for example, name, address (for example, certain dong, certain gu, Seoul), phone number (for example, 010-XXXX-XXXX), etc.

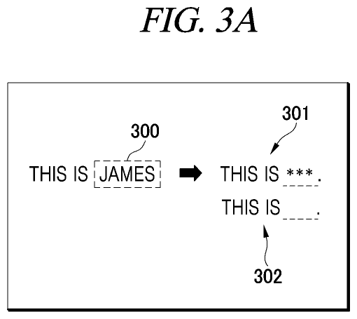

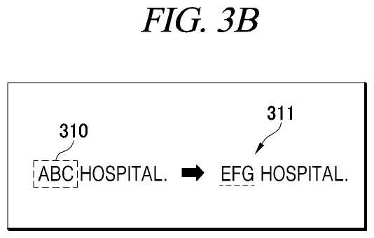

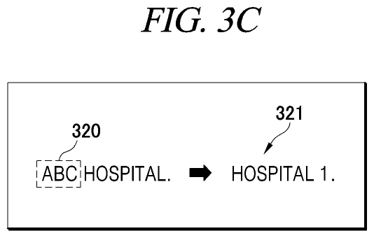

The training data generation unit 140 may generate training data on the conversational data by de-identifying text corresponding to the searched de-identification target token. For example, the training data generation unit 140 may generate training data on the conversational data by de-identifying, such as deleting, replacing, tagging, categorizing, text corresponding to the de-identification target token. A process of generating training data on conversational data by de-identifying text will be described in detail with reference to FIG. 3A to FIG. 3C.

FIG. 3A to FIG. 3C are diagrams showing an example of a process of generating training data on conversational data by de-identifying text according to an embodiment of the present disclosure.

Referring to FIG. 3A, the training data generation unit 140 may generate training data by de-identifying text corresponding to a de-identification target token, such as deleting the text or replacing the text with a special character.

Herein, the training data generation unit 140 may use a simple anonymization technique through attribute value deletion, attribute value partial deletion, data row deletion and identifier removal to delete text corresponding to an unnecessary value or an important value for individual identification among the values included in the dataset according to the purpose of data sharing and opening and to process words, which are highly likely to contribute to individual identification, to be invisible by adding random noise and combining with public information by using spaces and alternative techniques.

For example, if a sentence including personal information is “This is James”, the training data generation unit 140 may generate training data by de-identifying text “James” 300 corresponding to a de-identification target token of the sentence, such as replacing “James” 300 with a special character “***” 301.

For another example, the training data generation unit 140 may generate training data by de-identifying text corresponding to a de-identification target token of a sentence, such as deleting the text and making a blank 302 where the text was located.

Referring to FIG. 3B, the training data generation unit 140 may generate training data by de-identifying first text corresponding to a de-identification target token, such as replacing the first text with second text included in the same tag set as the first text. Herein, the training data generation unit 140 may use techniques, such as heuristic anonymization, K-anonymization, encryption and swapping, to replace major identification factors in personal information with other values and make it difficult to identify an individual.

For example, if a sentence including personal information is “ABC hospital”, the training data generation unit 140 may generate training data by de-identifying first text “ABC hospital” 310 corresponding to a de-identification target token of the sentence, such as replacing “ABC hospital” 310 with second text “EFG hospital” 311 included in the same tag set, i.e., hospital.

Referring to FIG. 3C, the training data generation unit 140 may generate tag information based on attribute information of text corresponding to a de-identification target token and generate training data by de-identifying the text, such as replacing the text with the tag information.

For example, if a sentence including personal information is “ABC hospital”, the training data generation unit 140 may generate tag information “hospital 1” 321 based on attribute information (parent category) of text “ABC hospital” 320 corresponding to a de-identification target token of the sentence and may generate training data by de-identifying the text “ABC hospital” 320 corresponding to the de-identification target token, such as replacing the text with the tag information “hospital 1” 321.

Although not illustrated in FIG. 3A to FIG. 3C, the training data generation unit 140 may also generate training data by de-identifying text corresponding to a de-identification target token, such as categorizing the text. Herein, the training data generation unit 140 may use techniques, such as data suppression, random rounding, data range, controlled rounding, etc., to convert a data value (for example, 35 years of age) into a category value (for example, 30 to 40 years of age) and conceal a definite value.

Referring back to FIG. 1, the training data generation unit 140 may generate different training data for each conversational service by de-identifying the text corresponding to the de-identification target token in a different format based on the type of the conversational service.

For example, the training data generation unit 140 may generate training data by de-identifying resident registration numbers, ages, addresses, nursing home symbols, incomes, sensitive diseases, and the like in order to provide a national healthcare forecast service that combines health insurance and social media information for major epidemic diseases.

For another example, the training data generation unit 140 may generate training data by de-identifying names, local information of smaller units than si, gun, gu (for example, detailed addresses of eup, myeon, dong), phone numbers (home, work, mobile, fax, etc.), email addresses, resident registration numbers, foreign registration numbers, passport numbers, registration numbers, health insurance card numbers, bank account numbers, qualification/license numbers, license plate numbers, bio-information, genetic information, member IDs, employee ID numbers, passwords, and the like in order to provide a healthcare big data utilization service for improving health care quality and reducing costs.

For yet another example, the training data generation unit 140 may generate training data by de-identifying ages, birthdates, IDs, diagnoses, drug prescription dates, diagnostic test dates, test dates, and the like in order to find out drug abuse or misuse cases and provide a drug safety early warning service based on big data for early response.

For still another example, the training data generation unit 140 may generate training data by de-identifying the sales of each store in order to provide a store evaluation service such as estimated sales of each store/evaluation of locational characteristics/evaluation of commercial power.

For still another example, the training data generation unit 140 may generate training data by de-identifying ages, billing addresses, and the like in order to support a night bus service through big data analysis.

For still another example, the training data generation unit 140 may generate training data by de-identifying nursing home information, doctor information, nurse information, addresses, nursing home symbols, and the like in order to provide a personalized medical information service through hospital information analysis.

For still another example, the training data generation unit 140 may generate training data by de-identifying resident registration numbers, ages, addresses, incomes, occupations, financial transaction history, credit information, and the like in order to provide micropayment information and marketing trend information based on NFC/LBS so as to be used as high-level marketing information by tracing credit card payment.

For still another example, the training data generation unit 140 may generate training data by de-identifying user IDs, addresses, phone numbers, resident registration numbers, mobile phone numbers, recipient names, and the like in order to provide a personalized book recommendation and distribution service by using book purchase information and customer information.

For still another example, the training data generation unit 140 may generate training data by de-identifying names, resident registration numbers, GPS, addresses, and the like in order to analyze civil complaint data accumulated through civil complaint, proposal, call center consulting and feed them back to policies.

Therefore, according to the present disclosure, a plurality of de-identified training data is generated by using a single dataset and thus can be applied to various conversational services.

The training data generation apparatus 100 may be executed by a computer program stored in a medium including a sequence of instructions to generate de-identified training data for conversational service. The computer program may include a sequence of instructions that, when executed by a computing device, cause the computing device to detect at least one sentence including personal information in a conversation between a user device and a chatbot, input conversational data including the at least one sentence into a personal information identification model, detect a de-identification target sentence through the personal information identification model, search a predefined de-identification target token from the conversational data when a de-identification target sentence is detected from the conversational data, and generate training data on the conversational data by de-identifying text corresponding to the searched de-identification target token.

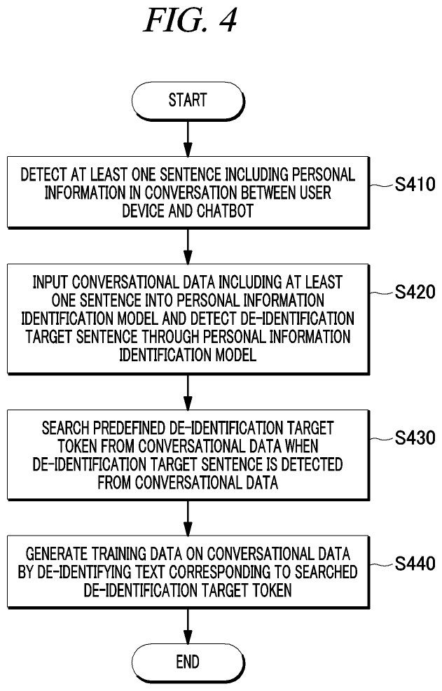

FIG. 4 is a flowchart showing a method of generating de-identified training data for conversational service, which is performed by a training data generation apparatus, according to an embodiment of the present disclosure. Referring to FIG. 4, the method for generating de-identified training data for conversational service, which is performed by the training data generation apparatus 100, includes the processes time-sequentially performed by the training data generation apparatus 100 according to the embodiment illustrated in FIG. 1 to FIG. 3C. Therefore, the above descriptions of the processes may also be applied to the method for generating de-identified training data for conversational service, which is performed by the training data generation apparatus 100, according to the embodiment illustrated in FIG. 1 to FIG. 3C, even though they are omitted hereinafter.

In a process 5410, the training data generation apparatus 100 may detect at least one sentence including personal information in a conversation between a user device and a chatbot.

In a process 5420, the training data generation apparatus 100 may input conversational data including the at least one sentence into a personal information identification model and detect a de-identification target sentence through the personal information identification model.

In a process 5430, the training data generation apparatus 100 may search a predefined de-identification target token from the conversational data when a de-identification target sentence is detected from the conversational data.

In a process 5440, the training data generation apparatus 100 may generate training data on the conversational data by de-identifying text corresponding to the searched de-identification target token.

In the descriptions above, the processes 5410 to 5440 may be divided into additional processes or combined into fewer processes depending on an embodiment. In addition, some of the processes may be omitted and the sequence of the processes may be changed if necessary.

A method of generating de-identified training data for conversational service, which is performed by a training data generation apparatus described above with reference to FIG. 1 to FIG. 4 can be implemented in a computer program stored in a medium to be executed by a computer or a storage medium including instructions codes executable by a computer. Also, the method of generating de-identified training data for conversational service, which is performed by a training data generation apparatus described above with reference to FIG. 1 to FIG. 4 can be implemented in a computer program stored in a medium to be executed by a computer.

A computer-readable medium can be any usable medium which can be accessed by the computer and includes all volatile/non-volatile and removable/non-removable media. Further, the computer-readable medium may include computer storage medium. The computer storage medium includes all volatile/non-volatile and removable/non-removable media embodied by a certain method or technology for storing information such as computer-readable instruction code, a data structure, a program module or other data.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. An apparatus for generating de-identified training data for conversational service, comprising:
a sentence detection unit configured to detect at least one sentence including personal information in a conversation between a user device and a chatbot;
a de-identification target sentence detection unit configured to input conversational data including the at least one sentence into a personal information identification model and detect a de-identification target sentence through the personal information identification model;
a search unit configured to search a predefined de-identification target token from the conversational data when a de-identification target sentence is detected from the conversational data; and
a training data generation unit configured to generate training data on the conversational data by de-identifying text corresponding to the searched de-identification target token.

2. The apparatus for generating de-identified training data for conversational service of claim 1,
wherein sentences in the conversation are stored sequentially in a buffer, and
the sentence detection unit is configured to understand intention of the sentences based on context of the sentences stored sequentially in the buffer and detect the at least one sentence.

3. The apparatus for generating de-identified training data for conversational service of claim 1,
wherein the sentence detection unit is configured to calculate a first probability that the at least one sentence will include the personal information.

4. The apparatus for generating de-identified training data for conversational service of claim 3,
wherein a second probability that each sentence will include the personal information is output from the personal information identification model, and
the de-identification target sentence detection unit is configured to detect the de-identification target sentence using the first probability and the second probability.

5. The apparatus for generating de-identified training data for conversational service of claim 1,
wherein the training data generation unit is configured to generate the training data by de-identifying the text corresponding to the de-identification target token, such as deleting the text or replacing the text with a special character.

6. The apparatus for generating de-identified training data for conversational service of claim 1,
wherein the training data generation unit is configured to generate the training data by de-identifying first text corresponding to the de-identification target token, such as replacing the first text with second text included in the same tag set as the first text.

7. The apparatus for generating de-identified training data for conversational service of claim 1,
wherein the training data generation unit is configured to generate tag information based on attribute information of the text corresponding to the de-identification target token, and generate the training data by de-identifying the text, such as replacing the text with the tag information.

8. The apparatus for generating de-identified training data for conversational service of claim 1,
wherein the training data generation unit is configured to generate different training data for each conversational service by de-identifying the text corresponding to the de-identification target token in a different format based on type of the conversational service.

9. The apparatus for generating de-identified training data for conversational service of claim 1,
wherein the personal information identification model is trained based on a dataset including the conversational data and a labelling of the de-identification target sentence.

10. A method for generating de-identified training data for conversational service, which is performed by a training data generation apparatus, comprising:
detecting at least one sentence including personal information in a conversation between a user device and a chatbot;
inputting conversational data including the at least one sentence into a personal information identification model and detecting a de-identification target sentence through the personal information identification model;
searching a predefined de-identification target token from the conversational data when a de-identification target sentence is detected from the conversational data; and
generating training data on the conversational data by de-identifying text corresponding to the searched de-identification target token.

11. The method for generating de-identified training data for conversational service of claim 10,
wherein sentences in the conversation are stored sequentially in a buffer, and
the detecting at least one sentence includes:
understanding intention of the sentences based on context of the sentences stored sequentially in the buffer and detecting the at least one sentence.

12. The method for generating de-identified training data for conversational service of claim 10,
wherein the detecting at least one sentence includes:
calculating a first probability that the at least one sentence will include the personal information.

13. The method for generating de-identified training data for conversational service of claim 12,
wherein a second probability that each sentence will include the personal information is output from the personal information identification model, and
the detecting a de-identification target sentence includes:
detecting the de-identification target sentence using the first probability and the second probability.

14. The method for generating de-identified training data for conversational service of claim 10,
wherein the generating training data includes:
generating the training data by de-identifying the text corresponding to the de-identification target token, such as deleting the text or replacing the text with a special character.

15. The method for generating de-identified training data for conversational service of claim 10,
wherein the generating training data includes:
generating the training data by de-identifying first text corresponding to the de-identification target token, such as replacing the first text with second text included in the same tag set as the first text.

16. The method for generating de-identified training data for conversational service of claim 10,
wherein the generating training data includes:
generating tag information based on attribute information of the text corresponding to the de-identification target token; and
generating the training data by de-identifying the text, such as replacing the text with the tag information

17. The method for generating de-identified training data for conversational service of claim 10,
wherein the generating training data includes:
generating different training data for each conversational service by de-identifying the text corresponding to the de-identification target token in a different format based on type of the conversational service.

18. The method for generating de-identified training data for conversational service of claim 10,
wherein the personal information identification model is trained based on a dataset including the conversational data and a labelling of the de-identification target sentence.

19. A non-transitory computer-readable storage medium storing a computer program including a sequence of instructions to generate de-identified training data for conversational service,
wherein the computer program includes a sequence of instructions that, when executed by a computing device, cause the computing device to:
detect at least one sentence including personal information in a conversation between a user device and a chatbot;
input conversational data including the at least one sentence into a personal information identification model, and detect a de-identification target sentence through the personal information identification model;
search a predefined de-identification target token from the conversational data when a de-identification target sentence is detected from the conversational data; and
generate training data on the conversational data by de-identifying text corresponding to the searched de-identification target token.
